(19) United States
(12) Patent Application Publication
(10) Pub. No.: US 2025/0226728 A1
(43) Pub. Date: Jul. 10, 2025

(54) ELECTRIC MACHINE HAVING A YOKE WINDING

(71) Applicant: C. & E. Fein GmbH, Schwaebisch Gmuend/Bargau (DE)

(72) Inventor: Bernd MAYER, Ellwangen (DE)

(73) Assignee: C. & E. Fein GmbH, Schwaebisch Gmuend/Bargau (DE)

(21) Appl. No.: 19/015,121

(22) Filed: Jan. 9, 2025

(30) Foreign Application Priority Data
Jan. 9, 2024 (EP) 24 150 908.2
Nov. 26, 2024 (EP) 24 215 459.9

(51) Int. Cl. H02K 9/14; H02K 1/14; H02K 1/2706; H02K 1/2786; H02K 15/095; H02K 15/40

(52) U.S. Cl. CPC H02K 9/14; H02K 1/145; H02K 1/2706; H02K 1/2786; H02K 15/095; H02K 15/40; H02K 2201/03

(57) ABSTRACT

An electric machine, in particular an electric motor, having an encapsulated magnetic air gap and the yoke ring of the stator being wound instead of the pole shoes. A method for manufacturing the electric machine is also provided.

This nonprovisional application claims priority under 35 U.S.C. § 119 (a) to European Patent Application No. 24 150 908.2, which was filed in Europe on Jan. 9,2024, and to European Patent Application No. 24 215 459.9, which was filed in Europe on Nov. 26, 2024, which are both herein incorporated by reference.

### BACKGROUND OF THE INVENTION

### Field of the Invention

The present invention relates to an electric machine having a toroidal winding of the stator yoke (yoke winding), in particular on a brushless electric machine.

### Description of the Background Art

Brushless motors are known from the prior art. They include the widely used asynchronous motors and the predominantly permanent magnet-excited synchronous motors, which are being used more and more even in electric tools, due to their high power density.

Electric tools transport high full-load power, which is why the motor and the power semiconductors of the electronics must be cooled. The preferred cooling medium is ambient air, which, however, contains dust as a result of the usually mechanical processing process of the electric tool. A compromise between cooling and dust resistance may be achieved by various dust filters or by components having suitable encapsulation. Electrically and magnetically conductive dusts occur, in particular during metalworking. Angle grinders generate particularly fine-grained dust. However, mineral or organic dusts (wood) may also clog the cooling air paths in the interior of the machine. The dust-containing ambient air also represents a disturbance variable which limits the duration of use. This results in the need for maintenance and repair.

For brushless drives, the magnetic air gap between the rotor and the stator is the dust-critical zone to be encapsulated, due to the open poles in the magnetic circuit. Known designs encapsulate the entire motor. The particularly high-loss stator winding is also encapsulated thereby, and a disadvantage arises over designs in which only the air gap is separated from the cooling air. Designs of this type use sealing of the air gap via injection molding or by wedges inserted into the slots. The strategy of encapsulated drive components has proven to be successful, especially for angle grinders.

There are different strategies for handling dust in ambient air. This dust often occurs, but not only during the machine's own processing process. Machines are thus also endangered which themselves produce only course chips and yet are used in locations where, for example, adjacent grinding work is taking place. The problem therefore arises not only with regard to electric tools such as angle grinders.

In contrast to the frequently used strategy of keeping dust out of the interior of the machine with the aid of dust screens, it is also occasionally guided past the encapsulated components via the largest possible gap sizes.

There are also approaches for filtering the dust in the interior of the machine out of the air and thus using cleaner air for cooling without complete encapsulation (e.g., cyclone principle), although especially fine-grained dust, in particular, poses a risk, and the aforementioned approaches work only with a rotating drive. However, dust is also present in the interior of the machine while it is turned off and enters openings during changes in location.

Dealing with unavoidable dusts of a finite size by encapsulating the critical system elements and passing them through as unobstructed as possible, using the best possible exchange of heat with the system elements to be cooled, seems to be an expedient technical approach.

Radial flux motors can be divided into motors having internal rotors or external rotors. Internal-rotor motors have the greater performance potential and often better satisfy the demands of electric tools.

A permanently excited synchronous motor is known from U.S. Pat. No. 4,547,713, which has a toroidal winding of the stator, which is designed purely as a ring without the formation of grooves or teeth. As a result, the width of the magnetic air gap between the rotor and stator is disadvantageously influenced by the winding itself, since the air gap must be at least the same width as the winding built up on the side of the stator facing the rotor.

U.S. Pat. No. 6,924,574 also describes a toroidally wound radial flux motor, which, however, includes an internal rotor as well as an external rotor. The stator ring includes inwardly facing and outwardly facing teeth, by which means, on the one hand, the magnetic air gap may be kept narrow, and, on the other hand, it may span a large surface area. A disadvantage is that the stator winding may be cooled only with difficulty in its gap between the two rotors, and a dust protection of the magnetic air gap is also made complex by the rotors moved on all sides.

A switched reluctance motor is known from US 2014/0125155, which allows two stator fields in phase opposition, each having a 180° pitch, to rotate synchronously with a multiplicity of coils and a commutation device. The rotor aligns itself due to its reluctance, and the system forms a rotating electromagnet, whose torque is constant, and the revolutions per minute may be set by the rotational speed of the two stator fields.

Stators are differentiated between those with concentrated windings and those with distributed windings. In connection with the electronic control, there are a wide range of design variants, which, of course, influence costs and manufacturing techniques. Due to their easy ability to be manufactured, concentrated windings are the standard in electric tools.

The present invention deals primarily with the stator and its winding. A classic stator is made up of the teeth (pole shoes) and the spaces between these teeth, the slots. The windings are mounted on the teeth in the classic manner. A large number of ampere windings (large number of windings with the thickest possible wire) is needed for a high efficiency. Correspondingly, the slots must be filled with copper as best as possible. The so-called slot fill factor is also evaluated for an estimation of the efficiency. At the same time, the highest losses under load are in the copper itself, by which means the cooling air is to flow around the latter as best as possible. These two requirements conflict with each other, since either only a lot of copper or only a large amount of cross-section may be available in the slot for cooling.

Needle winders for concentrated windings, however, do not achieve high slot fill factors, nor do they leave much cross-section available for through-draft ventilation (due to limited wire tension and thus bulging windings). An optimization of the geometric parameters is also in opposition between the largest possible air gap diameter and a high slot fill factor, since a large number of ampere windings usually requires a great need for radial installation space, and the cross-section of the air gap is reduced for ventilation with a constant radius of the rotor.

In the case of single-tooth windings, it is possible to manufacture windings situated precisely close to each other and thus to achieve a high slot fill factor. However, the competition between a high slot fill factor and a large cross section for through-draft ventilation remains.

### SUMMARY OF THE INVENTION

It is therefore an object of the invention to provide an electric machine having improved winding cooling.

The invention relates to, among other things, an electric machine having an EC motor, which comprises: a stator having a magnetic yoke ring, which is concentrically circumferential in axial direction A and which has multiple pole shoes on a concentrically running first side, which limit a concentrically running, cylindrical or hollow-cylindrical rotor receiving chamber; a rotor, which is arranged concentrically to the stator in the rotor receiving chamber; and a coolant flow chamber, which runs in the axial direction along a second side of the yoke ring which is situated opposite the first side, and the stator including multiple windings having a conductive wire, which are each wound around an axially running segment section of the yoke ring and which adjoin the coolant flow chamber.

The electric machine according to the invention has the advantage that the stator windings are arranged at least partially directly in the cooling air flow of the coolant flow chamber. In this way, the windings are cooled efficiently. The air gap between the rotor and the stator may be efficiently protected against dust penetration by the seal, in particular covers, which are mounted on the axial ends of the stator and rotor. The conflict between the slot fill factor and coolant air flow present in the prior art due to the tooth winding is eliminated by the invention.

It is also advantageous that, compared to machines having the classic tooth winding, the diameter of the cylinder jacket-shaped magnetic air gap, measured with respect to center point M indicated by axis A, may be enlarged, since the teeth are needed only for conducting the magnetic flux but not for establishing the windings or as cooling spaces.

As a further advantage, it was ascertained that, in its capacity as a mechanical energy store, the rotor may be enlarged in diameter and its performance improved thereby. The energy storage is supportive for a dynamic power output during load peaks. Energy stored as a rotary pulse in the rotor may be called up immediately at the power take-off. Electrical energy stores, however, must be called up only by controllers (e.g., software) and be converted by the electromagnetic system (latency). They must also be designed to be larger than a mechanical energy store by the factor (1/efficiency) of the electromagnetic conversion. The performance of many types of electric tools is based on the mechanical energy storage in the rotating parts.

An air gap can be formed between the pole shoes and the rotor, which has, in particular, a cylinder jacket shape and runs, in particular, concentrically to axis A. The electric machine in this example, can have at least one seal for sealing the air gap.

Also, an air gap can be formed between the pole shoes and the rotor. Electric machines of this type preferably have at least one seal for sealing the air gap.

The seal can be, for example, at least one cover, which is arranged on the end of the stator and the rotor situated in the axial direction, in particular, on both ends. The cover may include at least one cover element. In the case of an electric machine designed as an internal-rotor motor, the cover extends in the radial direction between the axis (A) and the second side of the yoke ring and preferably does not extend into the coolant flow chamber. In the case of an electric machine designed as an external-rotor motor, the cover extends in the radial direction between the second side of the yoke ring and the outside of the rotor and preferably does not extend into the coolant flow chamber situated inside the stator.

The windings can protrude into the coolant flow chamber and can be spaced apart from the second side of the yoke ring in the radial direction.

Due to this arrangement, it is achieved that the winding itself may be cooled more efficiently by the air flow passing by, which facilitates a more effective removal of the heat loss occurring in the winding. At the same time, the high-loss iron of the yoke ring, i.e. the yoke, also benefits from an improved cooling, since the air flow is able to circulate unhindered and remove the heat from the yoke, due to the spatial separation between the winding and the second side of the yoke.

This structural measure ensures that, not only the winding, but also the yoke ring has an optimized air cooling. The distance between the outer edge of the yoke ring on the second side and the winding makes it possible for the air flow to flow around the yoke ring and remove the quantity of heat occurring in the iron-containing material.

It is proposed that this distance between the second side of the yoke and the winding, measured in the radial direction, should be at least 0.5 mm, preferably between 1 mm and 2 mm, or between 1 mm and 5 mm, to ensure a sufficient air throughput and thus an optimal cooling. A distance of this type ensures that the cooling generated by the air flow is distributed uniformly, and the winding as well as the yoke ring benefit from an improved thermal relief.

The winding in the outer region, i.e., in the direction radially outward from the second yoke side, can be designed in such a way that it is spread apart or fanned out, by which means a defined distance occurs between the individual winding wires. The distance is preferably at least 0.5 mm or more, in particular between 0.5 mm and 5.0 mm, which significantly improves the thermal properties of the winding. The spreading apart of the winding creates an enlarged surface, along which the passing air flow may flow. This expanded surface permits a more efficient heat dissipation, since the air flow is able to better remove the occurring heat from the winding wires.

The spreading apart ensures that the air flow may penetrate deeper into the winding, and a more intensive cooling is thus achieved. The distance between the winding wires also results in the fact that the wires are positioned at a certain angle to each other in the radial direction. This not only causes a better distribution of the air flow over the entire winding, but also a uniform cooling of the wires. The radial angle at which the winding wires are positioned in relation to each other also contributes to the fact that the heat development is not concentrated at individual points but rather uniformly.

In an example that the electric machine is designed as an internal-rotor motor, the coolant flow chamber can be formed between a casing, in particular a housing, of the electric machine, and the second side of the yoke ring.

The housing may be, in particular, a housing or a housing section of the apparatus or the electric tool which contains the electric machine.

The electric machine can be designed as an external-rotor motor, the coolant flow chamber preferably being formed in the cylindrical hollow space of the stator.

The yoke ring can include at least two pole shoes, which open into the yoke ring at two points spaced apart along the circumferential direction of the yoke ring. The section of the yoke ring arranged between these points, referred to as the segment region, includes, in particular, the winding with the conductive wire. In particular, the cross-section of this conductive wire may have different shapes, e.g., round, flat, or rectangular, or a combination thereof.

In particular, the yoke ring can have a number N of pole shoes and a number N of segment regions. The yoke ring preferably has at least N pole shoes, which open into the yoke ring at points spaced apart along the circumferential direction, the section of the yoke ring arranged between two adjacent points having a segment region which carries, in particular, one winding. The pole shoes are, in particular, integrally connected to the yoke ring. Preferably, 3<=N<=24. The number N is preferably M integral multiples of 3, i.e., in particular, N=M*3, where M>=1.

A winding runs, for example, toroidally around a segment region, so that the inside of the yoke ring situated in the radial direction (i.e., the first side of the yoke ring in the case of the internal-rotor motor; but the second side in the case of the external-rotor motor) and the outside of the yoke ring situated in the radial direction (i.e., the second side of the yoke ring in the case of the internal-rotor motor; but the first side in the case of the external-rotor motor) are covered by the windings.

The stator can have axially running hollow spaces, in particular, a number N of hollow spaces, a hollow space being limited by a segment region of the yoke ring, two adjacent pole shoes, and at least one cylinder jacket segment. The cylinder jacket segment is arranged, in particular, on a radial end of the pole shoe and in parallel to the rotor in the axial direction and is, in particular, part of the pole shoe. An air gap, in particular, is situated between the cylinder jacket segment and the rotor. It is kept as small as possible to minimize the magnetic resistance. The cylinder jacket segment may have an axially running recess or opening. The hollow spaces correspond to those in classic stators, which have slots provided with a tooth winding between the teeth, where they are also referred to as tooth spaces. Since half of the windings are, however, arranged outside the slots in the case of the yoke winding, the hollow spaces may be formed, in particular, to be radially smaller than in classic stators having tooth windings. As a result, it is possible to enlarge the diameter of the rotor with nearly the same installation space and thus increase the power.

The teeth preferably do not carry any windings. However, it is possible that a winding is additionally provided on at least one tooth, multiple teeth, or all teeth.

Regardless of the fact that the slots or the tooth spaces may be very small in a winding and control concept of an EC motor according to the invention, it is possible that one or multiple of these slots or these tooth spaces has/have sensors for capturing measured values, in particular data, for example, the rotor position, temperature, etc. These sensors may comprise, for example, one or multiple sensors, in particular Hall sensors, windings, or the like. The control device is preferably configured or programmed to capture the at least one measured value of the at least one sensor for capturing measured values and, in particular, to use it to control the motor.

The yoke ring can be assembled from multiple separate segment sections. One segment section preferably contains multiple segment regions or, in particular, one double segment region or triple segment region, which has two segment regions or three segment regions. A construction of the yoke ring from multiple segment sections offers the advantage of a more compact and overall easier winding of the yoke ring and thus an economical manufacturing. The separate segment regions are preferably connectable in a form-fitting manner.

The yoke ring can have multiple separate segment sections, each segment section being able to have one, two, three, or more segment regions. Each segment section may have at least one or exactly one pole shoe, which may be connected, in particular integrally, to the segment section. The yoke ring may have, in particular, at least one connecting section, which is used, in particular, to connect two segment sections which are adjacent to each other in the circumferential direction. The connecting section may be connectable to at least one or two segment section(s), in particular in a form-fitting manner.

The yoke ring may thus be formed from multiple separate parts. At least one of these parts, in particular the connecting section, may have at least one securing device for the purpose of securing the connection of the parts, in particular the connection of two adjacent parts, for example two connecting sections or one connecting section and two segment sections. A connector may have at least one, in particular exactly one, pole shoe of the yoke ring.

The securing device may contain, in particular, a slit in at least one connecting section, which is introduced into the connecting section, in particular in the radial direction from the outside to the inside. At least one wedge element can be provided, which is introduced into the slit in a force-fitting manner in an engagement position to generate a tension in the circumferential direction, with the aid of which the multiple parts of the yoke ring are press-fit stemmed. The securing device may alternatively contain at least one pin element, in particular a screw, with the aid of which adjacent, in particular screwable, parts are secured.

The at least one wedge element may extend along the entire axial length of the yoke ring or only along a partial section of the length of the yoke ring in the axial direction.

A wedge element may have a latch, with the aid of which the wedge element can be secured in the engagement position against an undesirable emerging of the wedge element in the radial direction. The latch may be a projection on the wedge element, which engages with a receptacle of the connecting section in the engagement position. Correspondingly, the latch may be a receptacle on the wedge element, with which a projection of the connecting section engages in the engagement position.

The arrangement of rotor and stator can have a maximum radius R; the stator preferably has a maximum extension L in the radial direction, preferably L<=f* R, preferably 0.1<=f<=0.5, preferably 0.2<=f<=0.45. The maximum extension L of the stator in the radial direction is, in particular, less than 0.5 times the size of radius R of the rotor in the case of the internal-rotor motor. This makes it possible to provide the rotor with a more massive design to improve its characteristic as an energy store.

The pole shoes may not have a winding. In particular, their radial extension may be minimized thereby.

In the case of an internal-rotor motor, the rotor can be provided only inside the stator, not outside the stator.

In the case of an external-rotor motor, the rotor can be provided only outside the stator, not inside the stator.

The electric machine can be designed as an electric motor, in particular an EC motor, in particular as a permanent magnet-excited synchronous motor.

The electric machine can be designed as an internal-rotor motor.

The electric machine is preferably designed as an external-rotor motor.

The invention also relates to an electric tool, in particular a hand-guided electric tool, in particular an angle grinder or a drilling machine having an electric machine according to the invention.

The invention also relates to a method for manufacturing an electric machine according to the invention, comprising the following steps: providing the stator, which has the yoke ring and multiple pole shoes; winding conductive wire around the yoke ring, in particular with a number N of windings; arranging the stator coaxially with the rotor; providing the coolant flow chamber adjacent to the second side of the yoke ring; preferably sealing the air gap between the stator and rotor with the aid of at least one seal.

In this method, it is provided, in particular, that the yoke ring is provided so as to be made up of multiple separate segment sections. It is preferred that the segment sections are wound before they are assembled, in particular joined together, to form the yoke ring or the stator. A method of this type for manufacturing or winding may be carried out particularly economically.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows a schematic front view of an EC motor according to the prior art;

FIG. 1b shows a perspective view of an EC motor according to the prior art;

FIG. 2a shows a schematic front view of an EC motor according to the prior art;

FIG. 2b shows a schematic front view of an EC motor according to the invention, according to an example;

FIG. 2c shows a schematic front view of an EC motor according to the invention, according to an example;

FIG. 3a shows a schematic front view of an EC motor designed as an

external-rotor motor according to the prior art;

FIG. 3b shows a schematic front view of an EC motor according to the invention, designed as an external-rotor motor, according to an example;

FIG. 4 shows a schematic front view of the EC motor according to the invention similar to the representation in FIG. 2c, without a winding;

FIG. 5 shows a perspective arrangement of a segment section of a yoke of the EC motor from FIG. 4, including a winding;

FIG. 6 shows the comparison of the electromagnetic effect between an EC motor having a tooth winding according to the prior art and an EC motor having a yoke winding according to the invention, whose phases are energized differently;

FIG. 7 shows a perspective view of an EC motor according to the invention according to an example, with an opened housing;

FIG. 8 shows an axial cross-section of the EC motor from FIG. 7;

FIG. 9 shows an axial cross-section of an EC motor with an axial sealing;

FIG. 10 shows an axial cross-section of an EC motor, including windings spaced apart on the second side of the yoke; and

FIG. 11 shows a radial section of the EC motor from FIG. 10.

### DETAILED DESCRIPTION

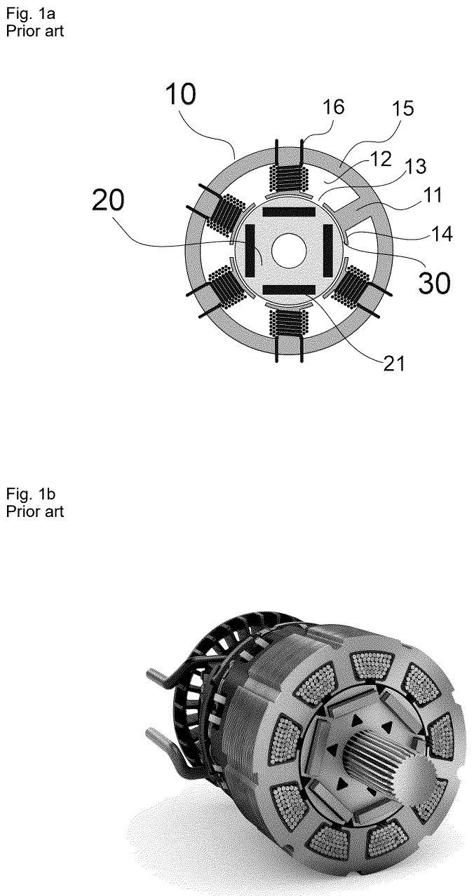

FIG. 1a shows a schematic front view of an EC motor according to the prior art. The EC motor is designed as an internal-rotor motor: Rotor 20 rotating around an axis rotates with the drive shaft within stator 10. Stator 10 includes teeth 11 acting as pole shoes and made from a material of high permeability, i.e., iron, which are connected via outer yoke ring 15, which is also referred to as yoke 15. Slots 12 are formed between teeth 11, which have a slot opening 13 formed between adjacent tooth heads 14 in the direction of rotor 20.

Each tooth has a winding 16 with copper wire. The circuit of the windings corresponds to a three-phase system. Two radially opposite windings are each assigned to one phase, since the motor is a motor having two pole pairs and thus 6 teeth/slots. Arrangements having a number of windings (teeth in this case) corresponding to a multiple of three are, in principle, possible in a three-phase motor. FIG. 1a does not show the winding of one of the six teeth in order to make the geometry of the tooth easier to recognize.

By supplying a three-phase current to the three phases, a rotating magnetic field forms on the motor. The field lines thereof run essentially in the ferromagnetic circuit, which is made up of teeth 11, the yoke ring (yoke 15), and rotor 20. The magnetic field lines also run through magnetic air gap 30, which is formed between the rotor and the tooth heads, and which is designed to be as narrow as possible for a low magnetic resistance. Since the magnetic field lines pass through the air gap in the radial direction, the motor is also referred to as a radial flux motor.

The rotor includes four permanent magnets 21 having different pole directions, two magnets of the same pole direction in each case being situated opposite each other radially in pairs.

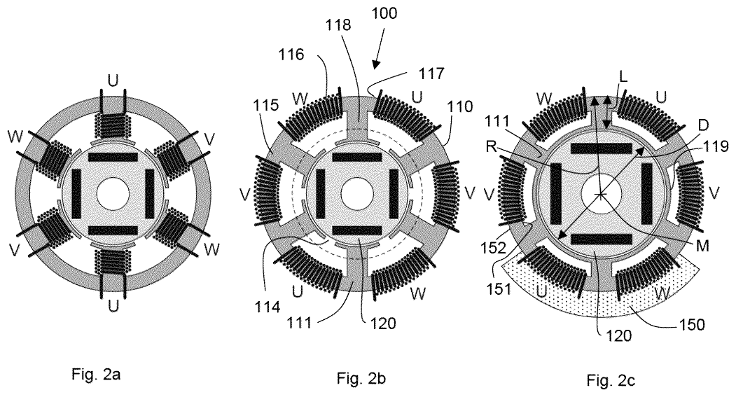

FIG. 2a again shows the known EC motor according to FIG. 1a, including the three phases u, v, w, which are each formed by two teeth formed radially opposite each other.

FIG. 2b shows a schematic front view of an EC motor 100 according to the invention, according to an example. Rotor 120 is identical to rotor 20. Stator 110 is also identical to stator 10 with the except of winding 16/116. Instead of laying the winding around the teeth, as in FIG. 2a, winding 116 in this case is guided around yoke 115, specifically around segment sections 117 situated between the connecting points of adjacent teeth 118. As a result, the windings may be referred to as toroidal, as is the case in toroidal core coils.

In FIG. 2b, the copper winding is also not mounted on the tooth in many layers, as in FIG. 2a, but on the yoke ring (the yoke) in a few layers (FIGS. 2b, 2c).

A coolant flow chamber 150 of the motor is shown only in sections in FIG. 2c, the coolant flow chamber actually running as a hollow space in the shape of a cylinder jacket between second side 152 of the yoke ring and a casing of the stator, e.g., of the motor housing. Coolant flow chamber 150 runs in the axial direction along a second side 152 of the yoke ring, which is opposite first side 151 of the yoke ring. First side 151 of the yoke ring is situated here such that it faces radially to the inside, second side 152 facing radially to the outside. Windings 116 are each wound around an axially running segment region of a segment section 117 of the yoke ring and into coolant flow chamber 150. The windings are cooled thereby efficiently and directly by the coolant flowing in the coolant flow chamber in the axial direction, air in this case.

FIG. 2c shows an arrangement which essentially corresponds to the arrangement in FIG. 2b, the space obtained by moving the winding from the teeth to yoke 115 is used within yoke 115 to increase diameter D of rotor 120 and to shorten the radial length of teeth 118 to a minimum. The slot openings were also omitted, and teeth 118 are connected radially on the inside, resulting in a radially closed sleeve 119 for the motor.

The possible increase in the outer diameter of the rotor also provides the possibility of likewise enlarging the inner diameter of the rotor or the outer diameter of the shaft, which is connected to the rotor. The stability of the shaft may be increased thereby. The enlarged inner diameter of the rotor additionally provides the possibility of using insulated or coated drive shafts.

A multiplicity of parameters is positively influenced by the arrangement according to the invention.

Yoke ring 115, which is usually seen only as magnetically necessary, on the outer circumference of the motor guides the entire magnetic flux and becomes the location of winding 116 according to the invention. As a result, teeth 118 may be radially smaller, and thus the distance of magnetic air gap 130 from center point M of the axis may be enlarged, and a larger diameter D of air gap 130 may thus be selected. The arrangement of rotor and stator has a maximum radius R, and the rotor has a maximum diameter D, wherein approximately D=1.4*R. Rotor 120 in FIG. 2c is therefore provided with a particularly massive design.

Since the winding of yoke ring 115 according to the invention is a toroidal winding 116, the stator may be formed from segments or segment sections, and these segment sections 117 may be individually wound independently of each other. For example, a stator 110 having 3 segment sections 117 is shown in FIG. 4. A precise and economical individual segment winding of individual segment sections 117 is possible thereby.

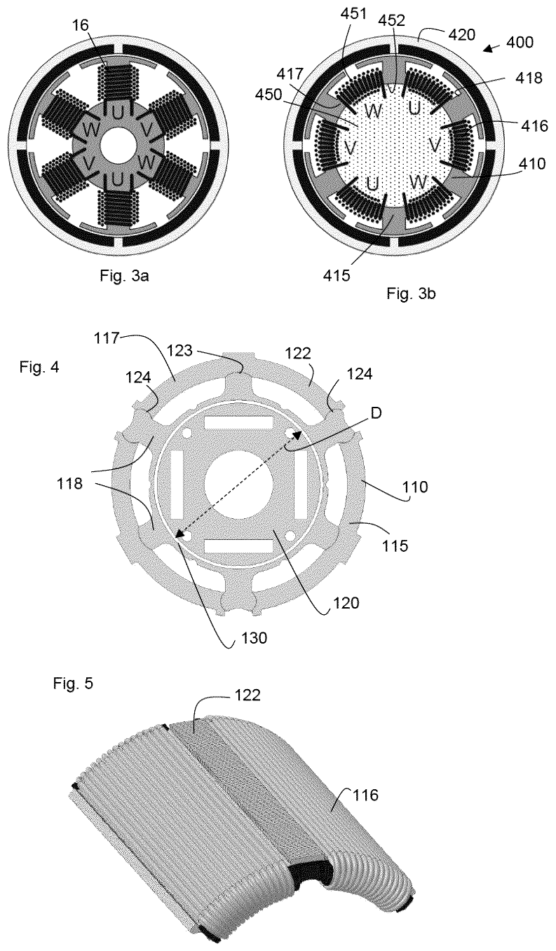

FIG. 3a shows a schematic front view of an EC motor designed as an external-rotor motor according to the prior art.

FIG. 3b shows a schematic front view of an EC motor 400 according to the invention, designed as an external-rotor motor, according to an example. Motor 400 includes stator 410, around which rotor (external-rotor motor) 420 rotates circumferentially on the outside. The inner-situated stator has a yoke ring 415 (yoke 415; specifically, yoke ring hollow cylinder 415) which runs circumferentially in an axially concentric manner, from which teeth 418 of yoke ring 415 extend radially to the outside. Winding 416 in this case is also wound around segment sections 417 of yoke 415, while the teeth here are again shortened and not wound.

A coolant flow chamber 450 of the motor is also shown in FIG. 3b. Coolant flow chamber 450 runs in the axial direction along a second side 452 of the yoke ring, which is opposite first side 451 of the yoke ring. First side 451 of the yoke ring is situated here such that it faces radially to the outside, second side 452 facing radially to the inside. Windings 416 are each wound around an axially running segment section 417 of the yoke ring and extend into coolant flow chamber 450. The windings are cooled thereby efficiently and directly by the coolant flowing in the coolant flow chamber in the axial direction, air in this case.

FIG. 4 shows the top view of a so-called sheet section. The stator and rotor are formed from a multiplicity of individual metal sheets to limit the disadvantageous effect of eddy currents.

FIG. 4 shows that, even with an even number of teeth/slots, the individual tooth winding may also be advantageously carried out via a winding of double segment sections 122. A double segment section 122 of this type is a segment section having two segment regions, each provided for one winding. Non-wound stator 110 illustrated in FIG. 4 has a yoke 115, which is made up of three double segment sections 122. A double segment section 122 is situated in each case centrally on a radially outer contact point 123 of a tooth 118, and is connected on its ends to an adjacent tooth 118, at a connecting point 124 in each case. All teeth 118 are preferably formed together via a fixed inner sheet section. In the case of an odd number of teeth/slots, an individual tooth winding may similarly take place via triple segment sections.

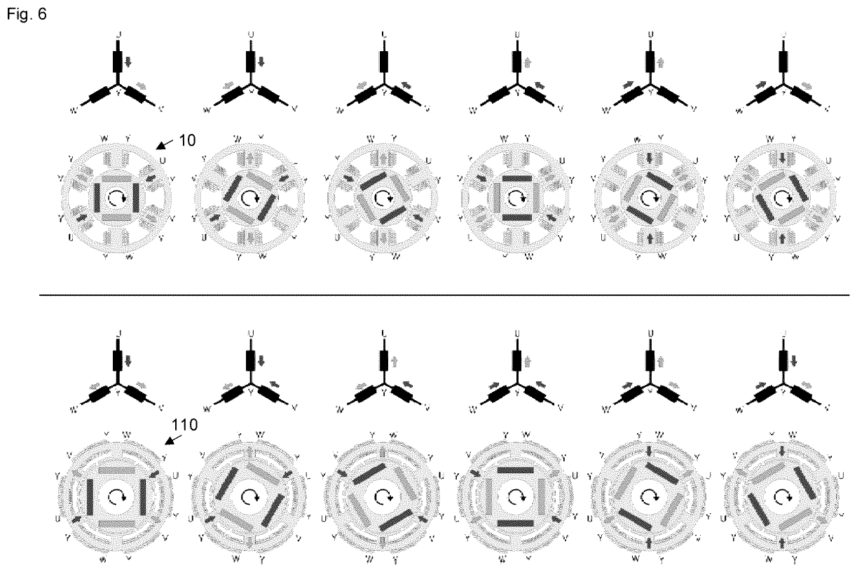

An example of a wound double-segment section 122 is apparent in FIG. 5. More ampere windings are achieved with the aid of 2 layers of winding 116 than in the case of tooth winding 16 having 4 layers (FIG. 3a), by which means a better cooling of the inner copper layer(s) is also possible.

The fixed portion of sheet section 118 ensures a concentric arrangement of the individual teeth, with the ability to center end shields, as well as a seamless sealing of the magnetic air gap. It also reduces the cogging torque of the EC motor.

Enlarged rotor 120 due to the increased air gap diameter facilitates a mechanical energy store, which increases with the square of diameter D, for smoothing the rotational speed during load peaks and due to control gaps, e.g. in mains machines with a slim DC link (AC ripple). If short braking times should be the criterion, the rotor may, of course, also be designed to have a lower rotational inertia via a larger plastic core or via openings in the sheet section.

Larger air gap diameter D also results in a higher torque constant. In the power class preferred here, this is usually indicated in mNm/A and has an influence on the full-load power and efficiency of the motor.

FIG. 6 shows the electromagnetic effect generated by a conventionally wound stator 10 (FIG. 2a) when two of its phases are alternately energized. In parallel thereto, it is shown how stator 110 according to the invention must be energized to achieve the same electromagnetic effect: this is shown based on the generated magnetic flux in relation to the position of the rotating permanent magnets. The result is that the control of the motor phases according to FIG. 6 should be changed for an identical electromagnetic effect.

To completely seal the magnetic air gap, it is provided as a preferred design feature to connect the end shields of the motor or also end caps without ball bearings to the fixed portion of the stator sheet section in such a way that the end-face openings of the magnetic air gap are closed, as is apparent in FIG. 2c in comparison to FIG. 2b. In this way, and due to the lack of slot openings 114, no dust may enter and clog the magnetic air gap.

At the same time, the end shields are centered with respect to the air gap. This may be used for both bearing sides for a self-supporting motor.

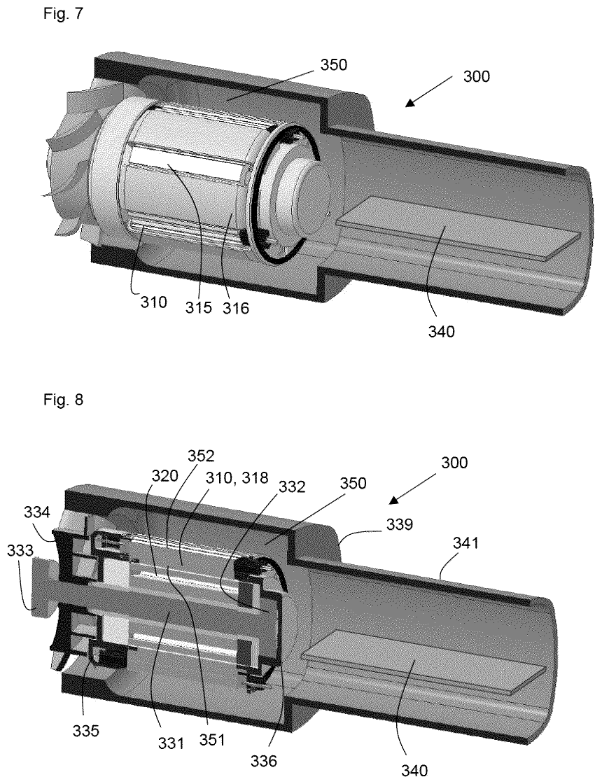

FIG. 7 and FIG. 8 show EC motor 300 according to the invention, which includes a stator 310 having windings 316 around a yoke, which are wound around segment sections, while teeth 318 are not wound. Motor electronics 340 extend in the axial direction from the interior of motor housing 339 into handle region 341.

Motor 300 includes a rotor 320, in which drive shaft 331 is fixed.

For drive 300, only rear bearing 332 (B side) is centered on the stator, and on the A side, shaft 331 is received in a gear head centered with respect to motor housing 339 via ball bearing 333. In order for a centering with respect to the air gap to occur here as well, stator 310 is correspondingly received by tool housing 339 and centered.

Cover element 335 arranged on an end of the stator/rotor or the motor and the cover element or end shield 336 arranged on the other end form a seal and encapsulate the motor region situated within yoke 315 in the axial direction in such a way that no dust may enter this motor region. At the same time, second side 352 of yoke 315 and winding 316 are situated directly in air-cooled coolant flow chamber 350, in this case intermediate space 350 between the motor and motor housing, in which the air flow generated by fan 334 achieves an optimal cooling effect in the axial direction.

An advantageous way to interconnect the motor windings is the use of insulation displacement contacts, which, in turn, are connected to form one of the 4 connection types (for three-phase systems: star or delta, and series or in parallel) with the aid of a printed circuit board.

Known BLDC motors (EC motors) have an outer diameter of the stator of 48 mm. However, fully encapsulated motors, in which the stator is also completely encapsulated, are constructed with their end shields made from diecast aluminum, which also represent a relevant cost factor. Maximum outer diameters of 58 mm are achieved here. With the present invention, this difference in diameter may be used either for a larger motor having more power or for the removal of dust or for a smaller gripping size.

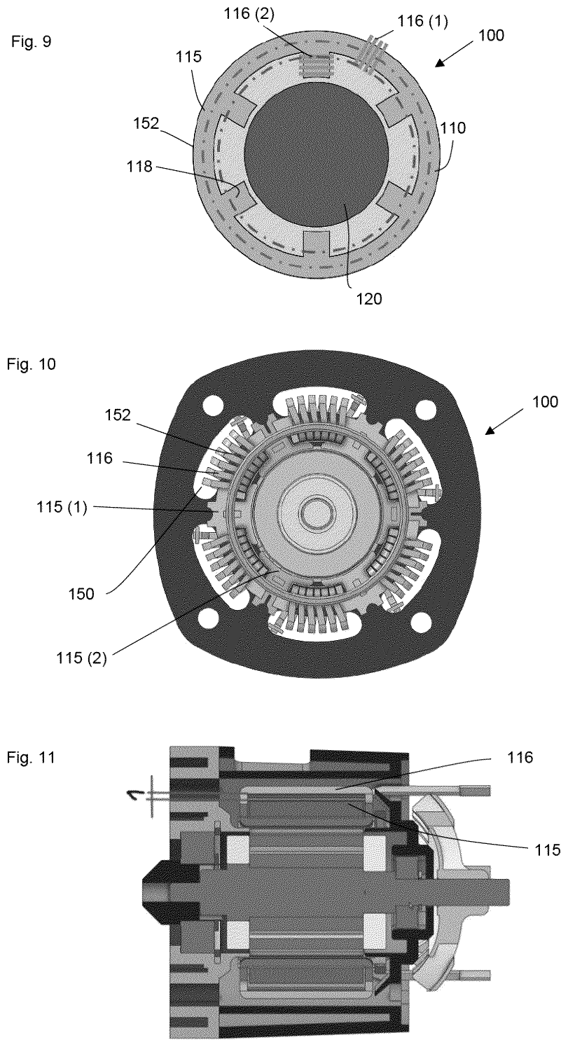

FIG. 9 sketches an axial sealing of the entire interior, including the magnetic air gap. The sealing of the magnetic air gap is intended to meet two requirements: Firstly, the largest possible portion of copper winding 116 should come into contact with the coolant to ensure an optimum heat dissipation. Secondly, the magnetic air gap is to be hermetically sealed to safeguard the functionality of the system.

For winding 116 (1) on yoke 115, both requirements are met by a sealing contour, represented by the outer of the two dash-dot lines. At least half of the winding 116 (1) is arranged in the cooling air flow, while the seal may be formed entirely as a cover placed on the motor in the axial direction, i.e., it may rest on the end face of the motor two-dimensionally and over a wide area. This design ensures a high manufacturing accuracy, since winding 116 (1) only slightly spreads out at the axial winding heads.

Conversely, in the case of a tooth winding 116 (2), which is not claimed, a suitable sealing contour may be implemented only with substantial complexity. The seal, indicated by the inner of the two dash-dot lines, is made possible only by a combination of axial and three-dimensional sealing measures. Only in this way may it be achieved that both a substantial portion of the copper winding 116 (2) comes into contact with the coolant and the magnetic air gap remains completely sealed.

FIG. 10 shows an axial section of an EC motor according to an example, including a preferably multi-part yoke ring as well as windings 116 protruding into coolant flow chamber 150. In the illustrated example, the yoke ring comprises in each case three parts 115 (1) and 115 (2) of essentially the same design, which, arranged in alternating sequence, form the yoke ring. The parts of group 115 (2), also referred to in each case as the connecting section of the yoke ring, furthermore have a slit on their radially externally situated ends, so that a wedge may be introduced into this slit to press-fit stem the stator. In this way, a connection already formed in a form-fitting manner of adjacent components of the yoke ring is further secured.

FIG. 10 furthermore shows that windings 116 protrude into coolant flow chamber 150 and are spaced apart from second side 152 of yoke ring 115 (1) and 115 (2) in the radial direction.

Due to this arrangement, a more efficient cooling of windings 116 is achieved by the passing air flow in coolant flow chamber 150, which results in a better heat dissipation of the losses occurring in windings 116. At the same time, the high-loss iron of the yoke ring also benefits from an optimized cooling, since the air flow is able to circulate unhindered due to the spatial separation between windings 116 and the yoke ring and thus removes the heat from the yoke ring.

This design ensures that both windings 116 and the yoke ring benefit from an improved air cooling. The distance between the outer edge of the yoke ring on second side 152 and windings 116 makes it possible for the air flow in coolant flow chamber 150 to flow around the yoke ring and remove the heat occurring in the iron of the yoke ring.

In the illustrated example, windings 116 in the outer region are designed in such a way that they are spread apart or fanned out, by which means a defined distance occurs between the individual winding wires. The spreading apart of windings 116 creates a larger surface, along which the passing air flow may flow. This enlarged surface permits a more efficient heat dissipation, since the air flow may better remove the resulting heat from the winding wires.

The spreading apart also ensures that the air flow in coolant flow chamber 150 may penetrate deeper into windings 116, and a more intensive cooling is thus achieved. The distance between the winding wires also causes the wires to be positioned at a certain angle to each other in the radial direction. This not only results in a better distribution of the air flow in coolant flow chamber 150 over entire winding 116, but also a uniform cooling of the wires. The radial angle of winding wires 116 contributes to the fact that the heat development is distributed uniformly and is not concentrated at individual points.

FIG. 11 shows the example of FIG. 10, the distance between winding 116 and the second side of yoke ring 115 being 1 mm in this case. A sufficient air throughput is ensured thereby and therefore an optimal cooling. A distance of this type furthermore ensures that the cooling is distributed uniformly, and winding 116 as well as yoke ring 115 benefit from an improved thermal relief.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electric machine comprising:
a stator having a magnetic yoke ring, which is concentrically circumferential in an axial direction and which has at least two pole shoes on a concentrically running first side that limit a concentrically running cylindrical or hollow-cylindrical rotor receiving chamber;
a rotor arranged concentrically to the stator in the rotor receiving chamber;
a coolant flow chamber, which runs in the axial direction along a second side of the yoke ring, which is opposite the first side, the stator having at least two windings having a conductive wire, which are each wound around an axially running segment section of the yoke ring and which adjoin the coolant flow chamber;
an air gap formed between the pole shoes and the rotor; and
at least one seal to seal the air gap.

2. An electric machine comprising:
a stator having a magnetic yoke ring, which is concentrically circumferential in an axial direction and which has at least two pole shoes on a concentrically running first side, which limit a concentrically running, cylindrical or hollow-cylindrical rotor receiving chamber;
a rotor arranged concentrically to the stator in the rotor receiving chamber; and
a coolant flow chamber, which runs in the axial direction along a second side of the yoke ring, which is opposite the first side, the stator having at least two windings having a conductive wire, which are each wound around an axially running segment section of the yoke ring and which adjoin the coolant flow chamber,
wherein the windings protrude into the coolant flow chamber and are spaced apart from the second side of the yoke ring in a radial direction.

3. The electric machine according to claim 2, wherein the windings are spread apart, so that a space is formed between individual winding wires.

4. The electric machine according to claim 1, wherein the rotor comprises at least one or multiple permanent magnets.

5. The electric machine according to claim 1, wherein the electric machine is an internal-rotor motor, and wherein the coolant flow chamber is formed between a casing or a housing of the electric machine and the second side of the yoke ring.

6. The electric machine according to claim 1, wherein the electric machine is an external-rotor motor, and wherein the coolant flow chamber is formed in a cylindrical hollow space of the stator.

7. The electric machine according to claim 1, wherein the yoke ring has at least two pole shoes, which open into the yoke ring at two points spaced apart along the circumferential direction of the yoke ring, the section of the yoke ring arranged between these point having this segment region.

8. The electric machine according to claim 1, wherein the yoke ring is assembled from multiple separate segment sections.

9. The electric machine according to claim 8, wherein a segment section contains multiple segment regions, or wherein a double segment section has two segment regions, and a winding is provided around each segment region.

10. The electric machine according to claim 1, wherein an arrangement of rotor and stator has a maximum radius R, and the stator has a maximum extension L in the radial direction, wherein L<=f*R, or 0.1<=f<=0.5, or 0.2<=f<=0.45.

11. The electric machine according to claim 1, wherein the pole shoes do not have any windings.

12. The electric machine according to claim 1, wherein the electric machine is an electric motor, or an EC motor, or a permanent magnet-excited synchronous motor.

13. The electric machine according to claim 1, wherein the electric machine is an internal-rotor motor.

14. The electric machine according to claim 1, wherein the electric machine is an external-rotor motor.

15. A method for manufacturing the electric machine according to claim 1, the method comprising:
providing the stator, which has the yoke ring and multiple pole shoes;
winding conductive wire around the yoke ring;
arranging the stator coaxially with the rotor; and
providing the coolant flow chamber adjacent to the second side of the yoke ring.
